(19) United States
(12) Patent Application Publication
(10) Pub. No.: US 2026/0364756 A1
(43) Pub. Date: Nov. 19, 2026

(54) Torque wrench for easy adjustment and positioning

(71) Applicant: Chung Chin WEI, Taichung City (TW)

(72) Inventor: Chung Chin WEI, Taichung City (TW)

(21) Appl. No.: 19/671,273

(22) Filed: May 8, 2026

(30) Foreign Application Priority Data
May 13, 2025 (TW) 114204750

(51) Int. Cl. B25B 23/142

(52) U.S. Cl. CPC B25B 23/1427

(57) ABSTRACT

A torque wrench includes a tubular torque rod pivotally connected to a wrench head shank. A push pin and spring are arranged in the shank. A torque adjustment assembly includes a ball screw, ball nut, adjustment member, indexing knob, and handle. A thrust bearing between the ball screw and positioning sleeve reduces friction by converting surface contact into rolling contact. The ball nut compresses the spring to adjust torque. Positioning teeth of the adjustment member engage annular teeth of the positioning sleeve, while the indexing knob selectively locks, restricts, or releases adjustment.

### TECHNICAL FIELD

The present invention relates to the technical field of torque wrenches, and more particularly to a torque wrench for easy adjustment and positioning, wherein a thrust bearing is disposed between a ball screw and a positioning sleeve of a torque adjustment assembly to convert surface-contact pressure into point or line rolling-contact pressure, a torque adjustment member is provided with positioning teeth for positioning engagement with annularly arranged teeth of the positioning sleeve, and an indexing knob enables locking, restricting, or releasing adjustment operations of the torque adjustment member.

### BACKGROUND

Conventionally, the difference between a general wrench and a torque wrench lies in that the torque wrench has a torque-setting function. Specifically, the torque wrench is provided therein with a release structure which generates vibration and an audible sound when a preset torque value is reached, thereby notifying a user that an applied force has reached the set value. Most adjustable torque wrenches include a tubular rod, one end of the tubular rod being connected to a working head, and another end thereof being provided with a handle. A torque structure is disposed on an exterior of the tubular rod and connected to a push rod structure within the tubular rod. The push rod structure performs linear reciprocating displacement under control of the torque structure, thereby compressing or releasing a torque adjustment assembly abutted thereby. The torque adjustment assembly pushes against an extension rod of the working head extending into the tubular rod, thereby adjusting a torque value of the working head. When the working head operates threaded fasteners such as screws or bolts, and the tightening degree reaches a preset torque value, a wrench body swings relative to the working head through an angular displacement, and an indication sound is generated inside the wrench body, whereby the operator may stop further force application.

However, in the above conventional torque wrenches, the torque structure controls the push rod structure to perform linear reciprocating displacement so as to compress or release the torque adjustment assembly abutted thereby. Such control is achieved through threaded engagement, wherein the threads drive one another through surface contact. In addition, due to the compressive force exerted by the spring used for torque setting, substantial operating force is required when a user rotates the torque structure. As a result, adjustment may be difficult, particularly for female operators. Furthermore, a conventional torque wrench generally needs to be reset to zero to release spring pressure after use. However, since the foregoing torque adjustment operation is already difficult, returning the torque wrench to zero requires even longer rotational adjustment, thereby making operation even more difficult for the user.

Accordingly, in view of the problems existing in the above conventional structures, how to develop an innovative structure with more ideal practicability has long been eagerly anticipated by consumers, and is also a goal and direction to which related manufacturers have continuously devoted research and development efforts.

In view of the foregoing, the creator, based on many years of experience in manufacturing, developing, and designing related products, after extensive design and prudent evaluation directed to the aforesaid objectives, has finally developed the present invention having practical utility.

### SUMMARY

A primary aspect of the present invention is to provide a torque wrench for easy adjustment and positioning, wherein a thrust bearing is disposed between a ball screw and a positioning sleeve of a torque adjustment assembly to convert surface-contact pressure into point or line rolling-contact pressure, a torque adjustment member is provided with positioning teeth for positioning engagement with annularly arranged teeth of the positioning sleeve, and an indexing knob enables locking, restricting, or releasing adjustment operations of the torque adjustment member.

To obtain the above-mentioned aspect, the torque wrench for easy adjustment and positioning provided by the present invention contains: a tubular torque rod pivotally connected to an outer periphery of a rear side of a wrench head shank, wherein a tail end of the wrench head shank is provided with a push pin and a push pin seat, a bottom end of the push pin seat abuts against one end of a pressure spring, and a torque adjustment assembly and a handle are assembled at a rear side of the torque rod. A ball screw, a torque adjustment member, an indexing knob and the handle of the torque adjustment assembly are assembled together through a pin rod. An elastic element is disposed between the torque adjustment member and the indexing knob. A thrust bearing is disposed between the ball screw and a positioning sleeve of the torque adjustment assembly, thereby converting surface-contact pressure into point or line rolling-contact pressure. A ball nut is assembled on the ball screw and presses against another end of the pressure spring through a washer. The torque adjustment member is provided with positioning teeth engageable with annularly arranged teeth of the positioning sleeve for positioning, and the indexing knob enables locking, restricting, or releasing adjustment operations of the torque adjustment member.

With regard to the techniques, means, and efficacy adopted by the present invention, a preferred embodiment is described in detail below in conjunction with the accompanying drawings, through which the above-mentioned objectives, structure, and features of the present invention may be more thoroughly and concretely understood.

### BRIEF DESCRIPTION OF THE DRAWINGS

FIG. 1 is a perspective view showing the assembly of a torque wrench for easy adjustment and positioning according to a preferred embodiment of the present invention.

FIG. 2 is a side cross-sectional plan view showing the assembly of the torque wrench for easy adjustment and positioning according to the preferred embodiment of the present invention.

FIG. 3 is a top cross-sectional plan view showing the assembly of the torque wrench for easy adjustment and positioning according to the preferred embodiment of the present invention.

FIG. 4 is a perspective view showing the exploded components of the torque wrench for easy adjustment and positioning according to the preferred embodiment of the present invention.

FIG. 5 is another perspective view showing the exploded components of the torque wrench for easy adjustment and positioning according to the preferred embodiment of the present invention.

FIG. 6 is a cross-sectional plan view showing the indexing knob positioned at a second position according to the preferred embodiment of the present invention.

FIG. 7 is another cross-sectional plan view showing the indexing knob positioned at a first position according to the preferred embodiment of the present invention.

FIG. 8 is also another cross-sectional plan view showing the indexing knob positioned at a zero position according to the preferred embodiment of the present invention.

FIG. 9 is a perspective view showing the exploded components of a thrust bearing according to the preferred embodiment of the present invention.

FIG. 10 is a perspective view showing the exploded components of the thrust bearing according to another preferred embodiment of the present invention.

### DETAILED DESCRIPTION

To enable the examiner to further understand and appreciate the objectives, features, and efficacy of the present invention, the embodiments thereof are described in detail below in conjunction with the accompanying drawings.

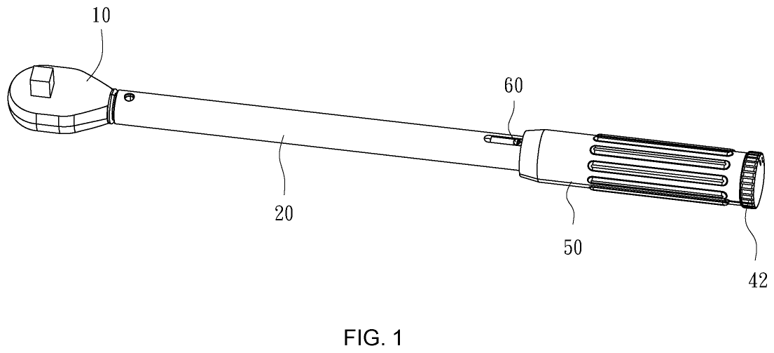

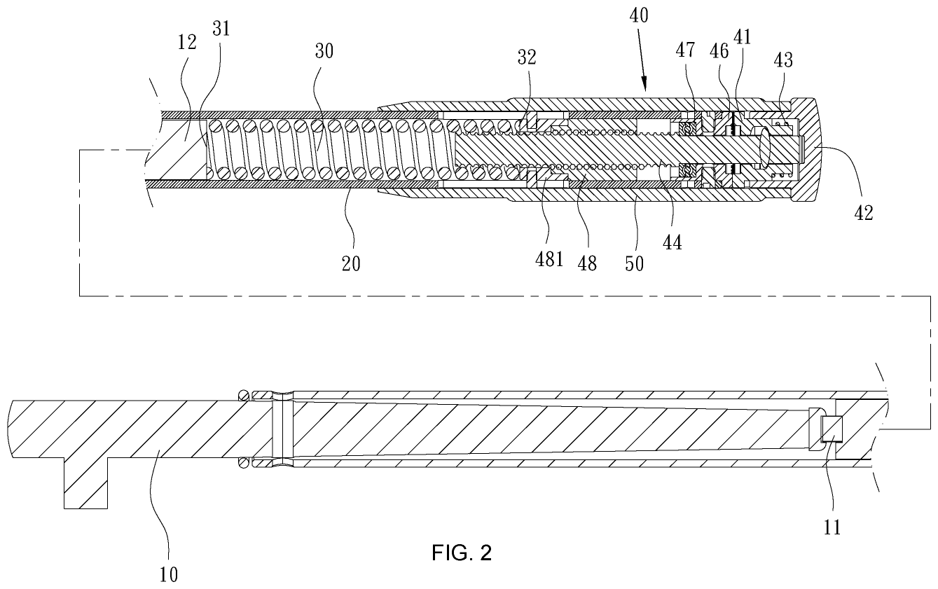

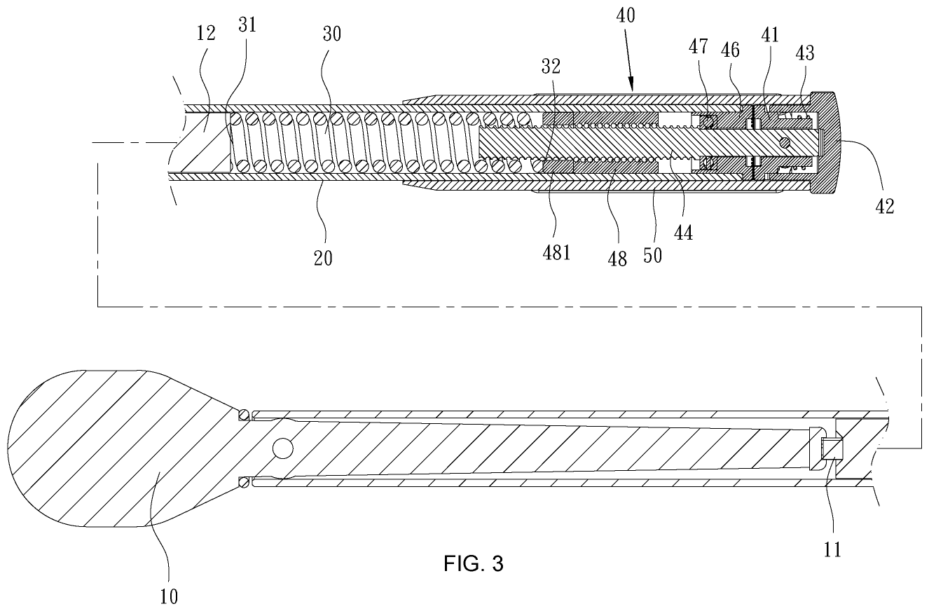

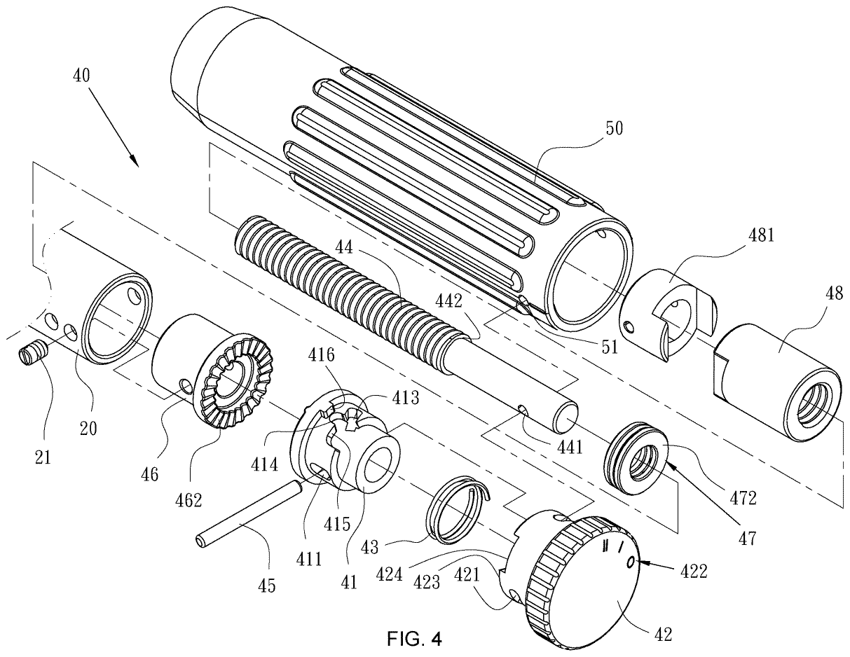

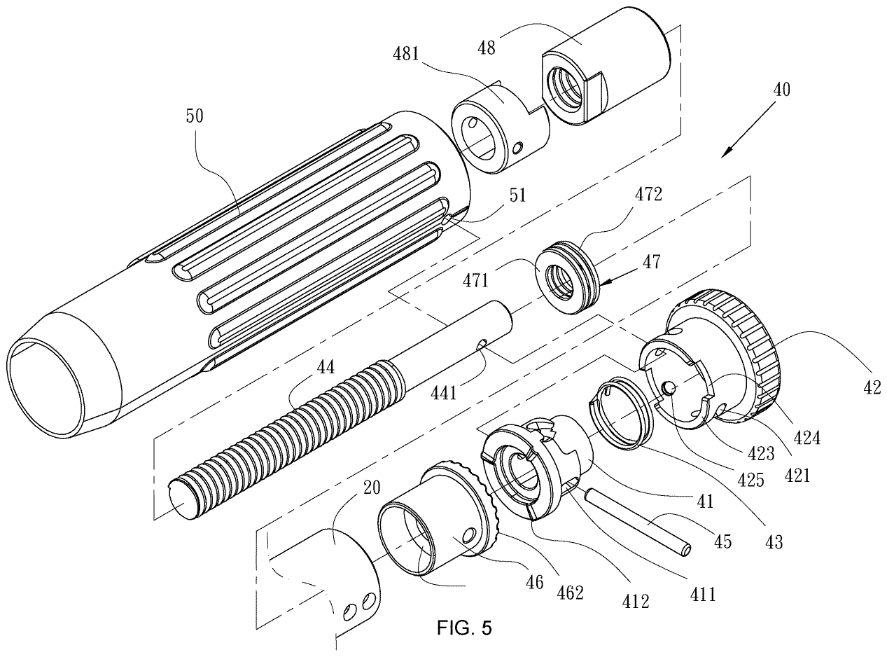

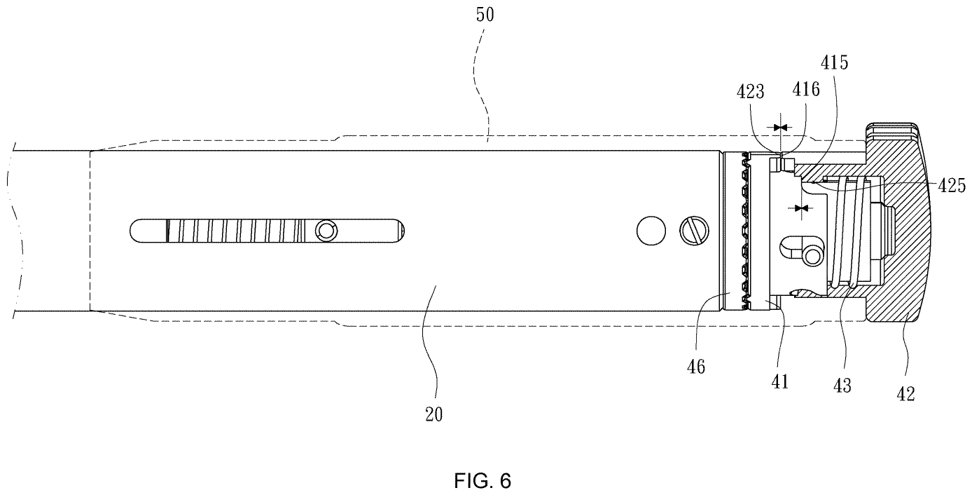

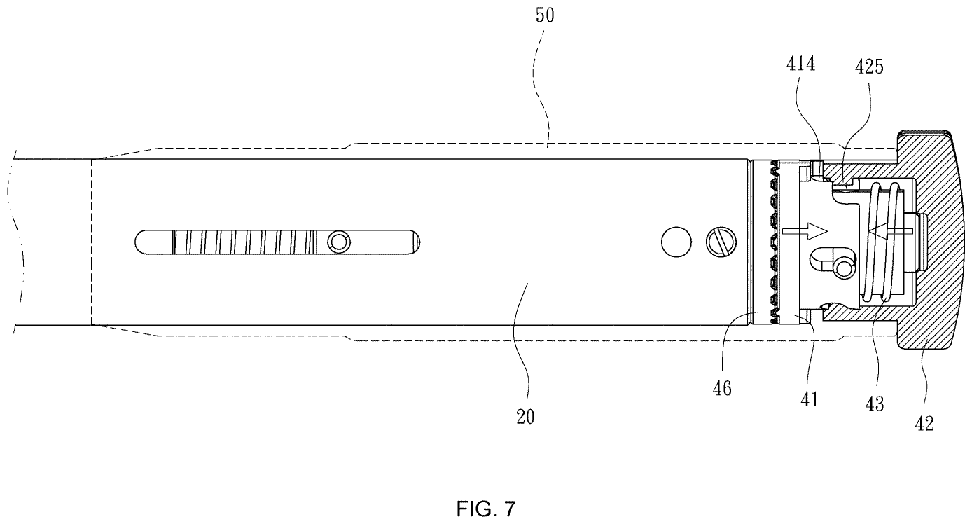

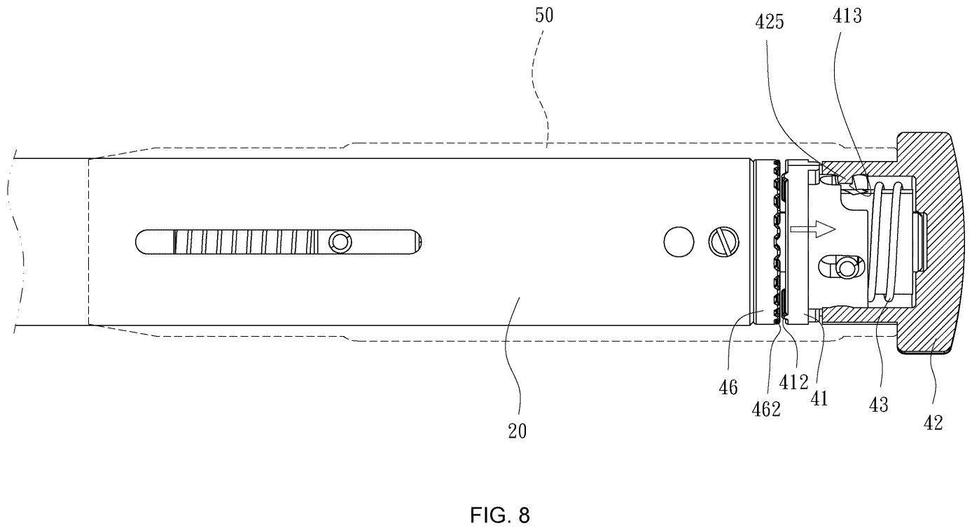

Referring to FIGS. 1 to 10, the present invention provides a torque wrench for easy adjustment and positioning, comprising:
a wrench head shank 10, wherein a tubular torque rod 20 is pivotally connected to an outer periphery of a rear side of the wrench head shank 10; a tail end of the wrench head shank 10 is provided with a push pin 11 and a push pin seat 12, a bottom end of the push pin seat 12 abutting against one end 31 of a pressure spring 30; and a torque adjustment assembly 40 and a handle 50 are assembled at a rear side of the torque rod 20; wherein
the torque adjustment assembly 40 is provided with a torque adjustment member 41, the torque adjustment member 41 being externally coupled with the handle 50 and an indexing knob 42. An elastic element 43 and a ball screw 44 are arranged between the torque adjustment member 41 and the indexing knob 42. The ball screw 44, the torque adjustment member 41, the indexing knob 42, and the handle 50 are respectively provided with a first pin hole 441, a second oval hole 411, a third oval hole 421, and a fourth pin hole 51 for insertion and assembly of a pin rod 45. A positioning sleeve 46, a thrust bearing 47, a ball nut 48, and a washer 481 are sequentially assembled in front of the torque adjustment member 41 on the ball screw 44, wherein the washer 481 abuts against the other end 32 of the pressure spring 30. The positioning sleeve 46 is fixed with the torque rod 20 by a fixing screw 21. The ball screw 44 is provided with a pushing surface 442 pressing against a first surface 471 of the thrust bearing 47, and the positioning sleeve 46 is provided with a pressing surface 461 pressing against a second surface 472 of the thrust bearing 47, thereby converting surface-contact pressure into point or line rolling-contact pressure. An end surface of the positioning sleeve 46 is provided with a plurality of annularly arranged teeth 462 facing one or more positioning teeth 412 of the torque adjustment member 41. The indexing knob 42 is provided with one indexing indication 422, two indexing flat surfaces 423, two indexing notches 424, and two indexing protrusions 425. The torque adjustment member 41 is provided with an inclined groove 413 corresponding to a zero position, a straight groove 414 corresponding to a first position, a platform 415 corresponding to a second position, and a protruding block 416. When the indexing knob 42 is rotated to the second position, the indexing protrusions 425 abut against the platform 415, and the indexing flat surfaces 423 press against the protruding block 416, such that the positioning teeth 412 of the torque adjustment member 41 tightly engage the annularly arranged teeth 462 of the positioning sleeve 46, thereby producing a positioning torque value effect after torque adjustment. When the indexing knob 42 is rotated to the first position, the indexing protrusions 425 enter the straight groove 414, and the torque adjustment member 41 is pushed by the elastic element 43 so that the positioning teeth 412 engage with the annularly arranged teeth 462 of the positioning sleeve 46. During torque adjustment, the positioning teeth 412 disengage and re-engage with the annularly arranged teeth 462, thereby producing a clicking sound and achieving indexed torque-stage adjustment. When the indexing knob 42 is rotated to the zero position, the indexing protrusions 425 enter the inclined groove 413, thereby pulling the positioning teeth 412 of the torque adjustment member 41 away from the annularly arranged teeth 462 of the positioning sleeve 46, whereby torque may be rapidly adjusted or reset to zero.

The torque wrench for easy adjustment and positioning as described above, wherein at least one scale ruler 60 is fixed on the torque rod 20.

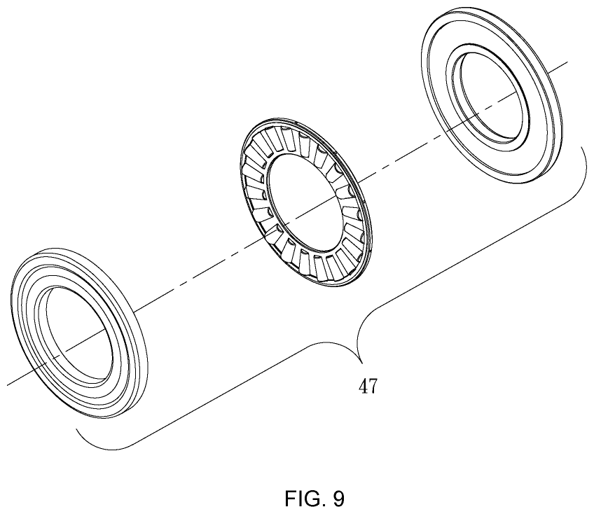

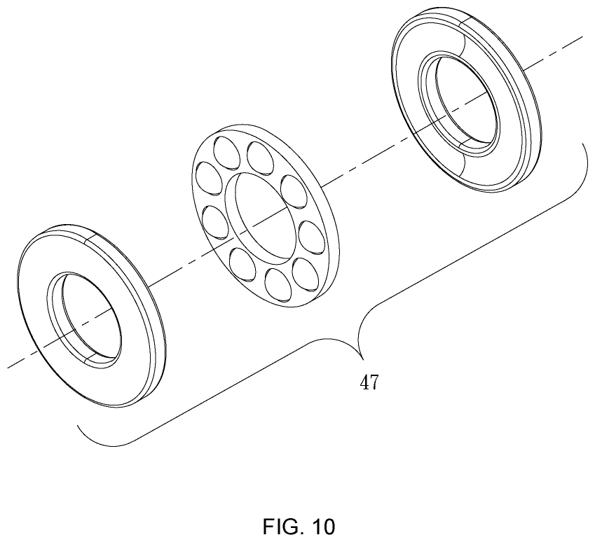

Referring to FIGS. 9 and 10, the torque wrench for easy adjustment and positioning as described above, wherein the thrust bearing 47 may be a ball thrust bearing or a needle thrust bearing.

From the foregoing, it can be appreciated that the torque wrench for easy adjustment and positioning of the present invention is unprecedented in the industry and satisfies the novelty requirement for a utility model patent. Its comprehensive innovative design also satisfies the inventive step requirement for a utility model patent. Further, a thrust bearing is disposed between the ball screw and the positioning sleeve of the torque adjustment assembly, thereby converting surface-contact pressure into point or line rolling-contact pressure. The torque adjustment member is provided with positioning teeth for positioning engagement with the annularly arranged teeth of the positioning sleeve, and the indexing knob enables locking, restricting, or releasing adjustment operations of the torque adjustment member, thereby providing favorable industrial applicability.

The foregoing descriptions are directed to preferred embodiments of the present invention and are intended to specifically illustrate the technical features of the present invention. However, those skilled in the art may make various modifications and changes without departing from the spirit and principles of the present invention, and all such modifications and changes shall fall within the scope of the appended patent claims.

In summary, the present invention provides a torque wrench for easy adjustment and positioning, which indeed achieves all of the objectives of the present invention. Furthermore, the spatial configuration of its assembled structure has not been seen in similar products, nor has it been publicly disclosed prior to the filing thereof, and therefore complies with the requirements of the Patent Act. Accordingly, this patent application is duly submitted in accordance with the law.

What is claimed is:

1. A torque wrench for easy adjustment and positioning, comprising:
a wrench head shank, a tubular torque rod being pivotally connected to an outer periphery of a rear side of the wrench head shank, a tail end of the wrench head shank being provided with a push pin and a push pin seat, a bottom end of the push pin seat abutting against one end of a pressure spring, a torque adjustment assembly and a handle being assembled at a rear side of the torque rod;
wherein the torque adjustment assembly includes:
a torque adjustment member;
an indexing knob, wherein the torque adjustment member is externally coupled with the handle and the indexing knob;
a ball screw, wherein the ball screw, the torque adjustment member, the indexing knob and the handle are respectively provided with a first pin hole, a second oval hole, a third oval hole and a fourth pin hole for insertion of a pin rod;
a positioning sleeve, wherein the positioning sleeve is fixed to the torque rod by a fixing screw;
a thrust bearing, wherein the ball screw is provided with a pushing surface pressing against a first surface of the thrust bearing, and the positioning sleeve is provided with a pressing surface pressing against a second surface of the thrust bearing, thereby converting surface-contact pressure into point or line rolling-contact pressure;
a ball nut; and
a washer,
wherein the positioning sleeve, the thrust bearing, the ball nut and the washer are sequentially assembled in front of the torque adjustment member on the ball screw, and the washer abuts against another end of the pressure spring.

2. The torque wrench for easy adjustment and positioning as claimed in claim 1, wherein an elastic element is disposed between the torque adjustment member and the indexing knob, the torque adjustment member is provided with an inclined groove corresponding to a zero position, a straight groove corresponding to a first position, a platform corresponding to a second position, and a protruding block, an end surface of the positioning sleeve is provided with a plurality of annularly arranged teeth, the torque adjustment member is provided with one or more positioning teeth facing the annularly arranged teeth, and the indexing knob is provided with two indexing flat surfaces, two indexing notches and two indexing protrusions;
wherein when the indexing knob is rotated to the second position, the indexing protrusions abut against the platform and the indexing flat surfaces press against the protruding block to form a locked state;
when the indexing knob is rotated to the first position, the indexing protrusions enter the straight groove, and the torque adjustment member is urged by the elastic element to form a restricted state; and
when the indexing knob is rotated to the zero position, the indexing protrusions enter the inclined groove so as to pull the torque adjustment member out of positioning engagement to form a released state.

3. The torque wrench for easy adjustment and positioning as claimed in claim 2, wherein the thrust bearing is a ball thrust bearing or a needle thrust bearing.

4. The torque wrench for easy adjustment and positioning as claimed in claim 3, wherein at least one scale ruler is fixed on the torque rod.

5. The torque wrench for easy adjustment and positioning as claimed in claim 4, wherein the indexing knob is provided with one indexing indication.
